(19) United States
(12) Patent Application Publication
(10) Pub. No.: US 2015/0024977 A1
(43) Pub. Date: Jan. 22, 2015

(54) METHOD FOR INHIBITING THE PLUGGING OF CONDUITS BY GAS HYDRATES

(71) Applicants: SHELL OIL COMPANY, Houston, TX (US); SHELL INTERNATIONALE RESEARCH MAATSCHAPPIJ B.V., The Hague (NL)

(72) Inventor: Ulfert Cornelis Klomp, Amsterdam (NL)

(21) Appl. No.: 14/366,470

(22) PCT Filed: Dec. 17, 2012
(86) PCT No.: PCT/US2012/070111

§ 371 Date: Jun. 18, 2014

Related U.S. Application Data
(60) Provisional application No. 61/577,815, filed on Dec. 20, 2011.

(51) Int. Cl. C09K 8/52

(52) U.S. Cl. CPC C09K 8/52
USPC 507/219

(57) ABSTRACT

A method for inhibiting the plugging of a conduit containing a flowable mixture comprising at least an amount of hydrocarbons capable of forming hydrates in the presence of water and an amount of water, which method comprises adding to the mixture an amount of a functionalized dendrimer effective to inhibit formation and/or accumulation of hydrates in the mixture at conduit temperatures and pressures; and flowing the mixture containing the functionalized dendrimer and any hydrates through the conduit wherein the functionalized dendrimer comprises at least one polyalkylene glycol end group.

### FIELD OF THE INVENTION

The present invention relates to a method for inhibiting the plugging by gas hydrates of conduits containing a mixture of low-boiling hydrocarbons and water.

### BACKGROUND OF THE INVENTION

Low-boiling hydrocarbons, such as methane, ethane, propane, butane, and iso-butane, are normally present in conduits, which are used for the transport and processing of natural gas and crude oil. When varying amounts of water are also present in such conduits the water/hydrocarbon mixture is, under conditions of low temperature and elevated pressure, capable to form gas hydrate crystals. Gas hydrates are clathrates (inclusion compounds) in which small hydrocarbon molecules are trapped in a lattice consisting of water molecules. As the maximum temperature at which gas hydrates can be formed strongly depends on the pressure of the system, hydrates are markedly different from ice.

The structure of the gas hydrates depends on the type of the gas forming the structure: methane and ethane form cubic lattices having a lattice constant of 1.2 nm (normally referred to as structure I) whereas propane and butane from cubic lattices having a lattice constant of 1.73 nm (normally referred to as structure II). It is known that even the presence of a small amount of propane in a mixture of low-boiling hydrocarbons will result in the formation of type II gas hydrates which type is therefore normally encountered during the production of oil and gas. It is also known that compounds like methyl cyclopentane, benzene and toluene are susceptible of forming hydrate crystals under appropriate conditions, for example in the presence of methane. Such hydrates are referred to as having structure H.

Gas hydrate crystals, which grow inside a conduit, such as a pipeline, are known to be able to block or even damage the conduit. In order to cope with this undesired phenomenon, a number of remedies have been proposed in the past such as removal of free water, maintaining elevated temperatures and/or reduced pressures or the addition of chemicals such as melting point depressants (antifreezes). Melting point depressants, typical examples of which are methanol and various glycols, often have to be added in substantial amounts, typically in the order of several tens of percent by weight of the water present, in order to be effective. This is disadvantageous with respect to costs of the materials, their storage facilities and their recovery, which is rather expensive.

Another approach to keep the fluids in the conduits flowing is taken by adding crystal growth inhibitors and/or compounds, which are in principle capable of preventing agglomeration of hydrate crystals. Compared to the amounts of antifreeze required, already small amounts of such compounds are normally effective in preventing the blockage of a conduit by hydrates. The principles of interfering with crystal growth and/or agglomeration are known.

U.S. Pat. No. 6,905,605 describes a method for inhibiting the plugging of a conduit containing a flowable mixture comprising at least an amount of hydrocarbons capable of forming hydrates in the presence of water and an amount of water, which method comprises adding to the mixture an amount of a dendrimeric compound effective to inhibit formation and/or accumulation of hydrates in the mixture at conduit temperatures and pressures; and flowing the mixture containing the dendrimeric compound and any hydrates through the conduit.

Some of the hydrate inhibitors described above have properties that are undesirable under certain circumstances. For example, some of the hydrate inhibitors have a low cloud point temperature. Above the cloud point temperature the solubility of these polymeric inhibitors in water decreases drastically which can result in the precipitation of sticky polymer masses.

It would be advantageous to develop hydrate inhibitors that have a high enough cloud point so that the inhibitor does not become cloudy (begin to precipitate solids) under conditions where the hydrate inhibitors are used.

### SUMMARY OF THE INVENTION

The invention provides a method for inhibiting the plugging of a conduit containing a flowable mixture comprising at least an amount of hydrocarbons capable of forming hydrates in the presence of water and an amount of water, which method comprises adding to the mixture an amount of a functionalized dendrimer effective to inhibit formation and/or accumulation of hydrates in the mixture at conduit temperatures and pressures; and flowing the mixture containing the functionalized dendrimer and any hydrates through the conduit wherein the functionalized dendrimer comprises at least one polyalkylene glycol functional end group.

### DETAILED DESCRIPTION OF THE INVENTION

The present invention relates to the field of hydrate inhibitors comprising functionalized dendrimer compounds with improved properties that are suitable for use in inhibiting the plugging of a conduit. A preferred embodiment of functionalized dendrimers is hyper-branched polyester amides.

Hyper-branched polyester amides are available commercially from DSM under the registered trademark Hybrane® in a variety of different types that comprise different functional groups. Whilst many generic types of such hyper-branched polymers exist, they are not all suitable for all applications. It would be desirable to find hyper-branched polymers which are particularly suitable particularly for hydrate inhibition.

It is a preferred object of the invention to solve some or all of the problems identified herein.

Certain hyper-branched polyester amides have a cloud point value above a minimum value (as tested under the conditions defined herein) are especially useful for inhibiting hydrates.

Whilst a few known hyper-branched polyester amides (such as comparative examples described herein) which have different structures from those of the invention may sometimes exhibit a cloud point above the minimum values described herein such known hyper-branched polyester amides then have other disadvantages and/or are not suitable for inhibiting the plugging of a conduit.

Therefore broadly in accordance with one aspect of the present invention there is provided a hyper-branched polyester amide having a cloud point of at least 50° C. where the polyester amide comprises at least one end group thereon selected from: polyalkylene glycol functional end groups (also denoted herein as E groups). Preferred end groups comprise polypropylene glycol polyethylene glycol, combinations thereof and/or copolymeric moeities thereof, more preferred end groups are polyethylene glycol groups (also denoted herein as EO groups). Preferred polyester amides of the invention are useful as flocculants.

Hyper-branched polyester amides of the present invention have a cloud point of at least 50° C., conveniently at least 55° C., preferably at least 60° C., more preferably at least 80° C., most preferably at least 90° C., in particular at least 100° C. as measured in one or more of the tests described herein as demineralised water (DMW) and/or in salt solution (such as that described herein as BRINE). Conveniently, polyester amides of the present invention have a cloud point value of at least one of the previously described values in at least one of DMW and BRINE, more conveniently in BRINE, most conveniently in both DMW and BRINE.

Where the polyester amides of the invention are hyper-branched polymers they may be prepared by the methods described in one or more of the publications below (and combinations thereof) and/or have structures as described thereto. The contents of these documents are incorporated by reference. It will be appreciated that the core structure of the polyester amide can be formed as described in any of the known ways described on the documents below that are otherwise consistent with the invention herein. The present invention relates to novel and improved polyester amides due to the nature of the end groups thereon and the core structure is less critical to the advantageous properties described herein.

In one embodiment of the invention the hyper-branched polyester amides may comprise, as a core structure, a moiety obtained or obtainable from polycondensation reaction between one or more dialkanolamines and one or more cyclic anhydrides. Optionally further end groups may be attached to the core structure as described herein.

The cyclic anhydride used to prepare the hyper-branched polyester amides of the invention may comprise at least one of: succinic anhydride, C₁-C₁₈ alkylsuccinic anhydrides, C₁-C₁₈ alkenylsuccinic anhydrides, polyisobutenylsuccinic anhydride, (optionally substituted) phthalic anhydride, (optionally substituted) cyclohexyl-1,2-dicarboxylic anhydride, (optionally substituted) cyclohexen-3,4-yl-1,2-dicarboxylic anhydride and/or a mixture of two or more thereof.

Another aspect of the present invention provides a composition comprising a hyper-branched polyester amide of the invention as described herein together with a diluent, conveniently water. Preferably the polyester amide is present in the composition in an amount of from 0.1% to 50%, more preferably 0.1% to 10%, and most preferably 0.1% to 5% by weight percentage of the total composition.

Hyper-branched polyester amides can be produced by polycondensation of the reaction product of dialkanolamines and cyclic anhydrides with optional modification of the end groups, as described in EP1036106, EP1306401, WO 00/58388, WO 00/56804 and/or WO07/098888.

The chemistry of the polyester amides allows the introduction of a variety of functionalities, which can be useful to give the polyester amides other additional properties. Preferred functional end groups comprise (for example are) —OH, —COOH, —NR₁R₂, where R₁ and R₂ can be the same or different C₁₋₂₂ alkyl, —OOC—R or —COOR, where R is an alkyl or aralkyl group. Other possible end groups are derived from polymers, silicones or fluoropolymers. Still other end groups are derived from (hetero)cyclic compounds, e.g., piperidine, morpholine and/or derivatives thereof. Hyper-branched polyester amides with these functionalities may be produced by any suitable method. For example carboxy functional hyper-branched polyester amide polymers are described in WO 2000/056804. Dialkyl amide functional hyper-branched polyester amide polymers are described in WO 2000/058388. Ethoxy functional hyper-branched polyester amide polymers are described in WO 2003/037959. Hetero functionalised hyper-branched polyester amides are described in WO 2007/090009. Secondary amide hyper-branched polyester amides are described in WO 2007/144189. It is possible, and often even desirable, to combine a number of different end group functionalities in a single hyper-branched polyester amide molecule in order to obtain desirable properties of the polymer.

The properties of a hyper-branched polyester amide may be modified by selecting the cyclic anhydride used to build up the polymer structure. Preferred cyclic anhydrides are succinic anhydride, alkylsuccinic anhydrides (where the length of the alkyl chain can vary from C₁ to C₁₈), alkenylsuccinic anhydrides (where the length of the alkenyl chain can vary from C₁ to C₁₈), polyisobutenylsuccinic anhydride, (optionally substituted) phthalic anhydride, (optionally substituted)cyclohexyl-1,2-dicarboxylic anhydride, (optionally substituted) cyclohexen-3,4-yl-1,2-dicarboxylic anhydride and other cyclic anhydrides. Especially preferred are succinic anhydride and cyclohexyl-1,2-dicarboxylic anhydride. It is possible to combine more than one type of anhydride to produce a hyper-branched polyester amide with the desired additional properties.

Additionally the anhydride can be partly replaced by the corresponding dicarboxylic acid to obtain the same product as e.g. succinic anhydride can be partly replaced by succinic acid.

In one embodiment the polyester amides of the invention may be obtained by both a cyclic anhydride and a diacid used together in the same process. Preferably the diacid is derived from the cyclic anhydride. A preferred weight percentage for the amount of anhydride is from 1 to 99%, more preferably from 10 to 90%, most preferably from 20 to 80% with respect to the total weight of anhydride and diacid. A preferred weight percentage of diacid is from 1 to 99%, more preferably from 10 to 90%, most preferably from 20 to 80% with respect to the total weight of anhydride and diacid.

The structure and properties of the polyester amides can be varied over a broad range of polarities and interfacial properties. This makes the hyper-branched polyester amides applicable to inhibiting plugging of a conduit where water soluble polymers are required at high temperature and/or in brine.

Hyper-branched polyester amides that may be used in the present invention are water soluble and may be optionally soluble in most organic solvents. A further yet still other aspect of the invention broadly provides for use of hyper-branched polyester amide as described herein in any of the methods of the invention described herein. The process of the present invention may use hyper-branched polyester amides alone or in combinations or formulations with other active ingredients as necessitated by specific applications. Examples of other compounds with specific activity are corrosion inhibitors, antifoaming agents, biocides, detergents, rheology modifiers and other functions as made necessary by the application. Application of the hyper-branched polyester amide in the process according to the invention may be as solid or liquid, or dissolved in a solvent which can be chosen by those skilled in the art.

Suitable apolar groups (end groups) may be optionally substituted hydrocarbo groups comprising at least 4 carbon atoms.

Preferred polyester amides of and/or used in the present invention comprise those in which the (average) ratio of polar groups to apolar groups is from about 1.1 to about 20, more preferably from 1.2 to 10, most preferably from 1.5 to 8.0. These ratios may be weight ratios and/or molar ratios, preferably are weight ratios.

Hyper-branched polyester amides of and/or used in the present invention may be obtained and/or obtainable from: at least one organo building block and at least one tri (or higher) organo valent branching unit, where the at least one building block is capable of reacting with the at least one branching unit; and at least one or the building block and/or the branching unit (conveniently the branching unit) comprises an end group comprising a polar moiety.

More preferred hyper-branched polyester amides of and/or used in the present invention may be obtained and/or obtainable from: at least one building block comprising one or more polycarboxylic acid(s) and/or one or more anhydride(s) obtained and/or obtainable from one or more polycarboxylic acid(s); and at least one branching unit comprising at least one tri functional nitrogen atom.

Suitable polycarboxylic acid(s) that may be used as and/or to prepare the building block(s) may conveniently be dicarboxylic acids such as C₂₋₁₂ hydrocarbon dicarboxylic acids; more conveniently linear di-acids and/or cyclic di-acids; and most conveniently linear di-acids with terminal carboxylic acid groups such as those selected from the group consisting of: saturated di-acids such as: 2-ethanedioic acid (oxalic acid); 3-propanedioic acid (malonic acid); 4-butanedioic acid (succinic acid); 5-pentanedioic acid (glutaric acid); 6-hexanedioic acid (adipic acid); 7-heptanedioic acid (pimelic acid); 8-octanedioic acid (suberic acid); combinations thereof; and mixtures thereof; and unsaturated di-acids such as: Z-(cis)-butenedioic acid (maleic acid); E-(trans)-butenedioic acid (fumaric acid); 2,3-dihydroxybutandioic acid (tartaric acid); combinations thereof; and/or mixtures thereof.

Useful hyper-branched polyester amides of and/or used in the present invention may be obtained and/or obtainable from at least one building block that comprises: optionally substituted C₂₋₃₀ hydrocarbon dioic acids and/or anhydrides thereof, combinations thereof on the same moiety; and/or mixtures thereof on different moieties;

More useful hyper-branched polyester amides of use in the present invention may be obtained and/or obtainable from at least one building block that comprises: C₄₋₁₆ alkenyl C₂₋₁₀ dioic anhydrides; C₄₋₁₆ cycloalkyl dicarboxylic acid anhydrides; C₂₋₁₀ alkane dioic anhydrides; (optionally substituted) phthalic anhydrides, combinations thereof on the same moiety and/or mixtures thereof on different moieties.

Most useful hyper-branched polyester amides of use in the present invention may be obtained and/or obtainable from at least one building block that comprises: dodecenyl (i.e. C₁₂ alkenyl) succinic anhydride; (optionally substituted) cyclohexane-1,2-dicarboxylic acid anhydride; succinic (i.e. 4-butanedioic) anhydride; combinations thereof on the same moiety; and/or mixtures thereof on different moieties.

Suitable branching units that may be used to prepare hyper-branched polyester amides of and/or used in the present invention may be any moiety capable of reacting with the building block and/or precursor therefor (such as any of those described herein) at three or more sites on the branching unit to form a three dimensional (branched) product. Branching units denote those units that form the core structure of the hyper-branched polyester amides and do not necessarily form end groups.

Usefully the at least one branching unit may comprise: diisopropanol amine; diethanolamine; trishydroxymethylene amino methane; combinations thereof on the same moiety; and mixtures thereof on different moieties.

Advantageously hyper-branched polyester amides of and/or used in the present invention may have a (theoretical) number average molecular weight (Mₙ) of from about 500 to about 50,000 g/mol; more advantageously from about 800 to about 30,000 g/mol; most advantageously from about 1000 to about 20,000 g/mol; even more particularly from about 1200 to about 17,000 g/mol.

The end group (or reagents and/or precursors therefore) may be introduced at any stage in the preparation of the polyester amide, though typically is introduced at the beginning. The end group may be attached at any point to the molecule. Preferably the at least one end group is selected from: alkoxy-terminated polyethylene glycol having a number average molecular weight of at least 600 daltons more preferably from 600 to 10000 daltons, even more preferably from 1000 to 7000 daltons, most preferably from 2000 to 5000 daltons.

It will be appreciated that species listed herein as examples of end groups, branching units and/or building blocks include all suitable derivatives and/or precursors thereof as the context dictates.

Polyester amides may also usefully exhibit other properties to be useful in inhibiting the plugging of a conduit. For example the polyester amides may exhibit at least one of those desired properties described herein and/or any combinations thereof that are not mutually exclusive.

Useful polyester amide(s) may exhibit one or more improved propert(ies) (such as those described herein) with respect to known polyester amides. More usefully such improved properties may be in a plurality, most usefully three or more of those properties below that are not mutually exclusive.

The known reference polyester amide for these comparisons is comparative example COMP 1 (prepared as described herein) used in the same amounts (and where appropriate in the same compositions and tested under the same conditions) as polyester amides of the invention being compared.

The percentage differences for improved and comparable properties herein refer to fractional differences between the polyester amide of the invention and the comparative example COMP 1 (prepared as described herein) where the property is measured in the same units in the same way (i.e. if the value to be compared is also measured as a percentage it does not denote an absolute difference).

It is preferred that polyester amides of the invention (more preferably hyper-branched polyester amides) have improved utility in inhibiting the plugging of a conduit described herein (measured by any suitable parameter known to those skilled in the art) compared to the comparative example COMP 1 (prepared as described herein). Many other variations embodiments of the invention will be apparent to those skilled in the art and such variations are contemplated within the broad scope of the present invention.

The hyper-branched polyester amide compounds can be added to the mixture of low-boiling hydrocarbons and water as their dry powder, or, preferably in concentrated solution. They can also be used in the presence of other hydrate crystal growth inhibitors.

It is also possible to add other oil-field chemicals such as corrosion and scale inhibitors to the mixture containing the hyper-branched polyester amide compounds. Suitable corrosion inhibitors comprise primary, secondary or tertiary amines or quaternary ammonium salts, preferably amines or salts containing at least one hydrophobic group. Examples of corrosion inhibitors comprise benzalkonium halides, preferably benzyl hexyldimethyl ammonium chloride.

### EXAMPLES

### Method to Determine Cloud Point

For determining the cloud point of the polyester amides the following procedure was followed.

In a 50 ml glass vial was weighted 140 mg of the polymer to which was added water or a brine solution to a total weight of 20 g In the case of amine containing polyester amides the pH was adjusted with 5% w/w HCl solution and the cloud point was measured at low pH. A Teflon coated stirrer bar was added to the vial and a thermocouple was immersed in the solution for at least 1 cm, approximately in the middle of the vial. The vial was placed on a stirrer/heater and the temperature was gradually increased while stirring. The solution was observed visually while warming and the cloud point was indicated by the first sign of cloudiness of the solution.

### Composition Salt Solution (Also Referred to Herein as BRINE)

For the determination of the cloud point in brine solutions the following salt composition was made: 140 g sodium chloride, 30 g calcium chloride.6H₂O, 8 g magnesium chloride.6H₂O. The salts were dissolved in 1 litre of demineralised water. The pH of the solution was adjusted to 4 (or another desired pH as specified) with 0.1M hydrochloric acid solution.

### EXAMPLES

The present invention will now be described in detail with reference to the following non-limiting examples which are by way of illustration only. These examples are highly-branched polyester amides containing polyethylene glycol groups (which are also referred to herein as polyethylene oxide functional hyper-branched polymers or EO hyper-branched polymers).

### Example 1

### Preparation of Highly Branched Polyester Amide Containing Polyethylene Oxide End Groups.

### Example 1

A double walled glass reactor, which can be heated by means of thermal oil, fitted with a mechanical stirrer, a distillation head, a vacuum and nitrogen connection was heated to 125° C. The reactor is charged with 20.4 g of hexahydrophthalic anhydride and 472.1 g of polyethyleneglycol monomethyl ether with average molecular weight of 5000. After stirring for 1 hour 7.5 g of diisopropanolamine were added. The temperature was increased to 180° C. and after 1 hours the pressure was gradually reduced to a final pressure of <10 mbar to distil off reaction water. Heating and vacuum were maintained until the residual carboxylic acid content was <0.3 meq/g (tritrimetrical analysis) to obtain, as a product, Example 1 which was characterised as follows:
AV=4.8 mgKOH/g. Molecular weight Mn=26000

### Examples 2 to 5

Preparation of Highly Branched Polyester Amides Containing Polyethyleneglycol End Groups and Also Amines and/or Cyclic Amides

### Example 2

A double walled glass reactor, which can be heated by means of thermal oil, fitted with a mechanical stirrer, a distillation head, a vacuum and nitrogen connection was heated to 55° C. The reactor was charged with: 133.7 g of hexahydrophthalic anhydride, 479.5 g of polyethylene glycol monomethyl ether with average molecular weight of 2000, 37.2 g of N-methylpiperazine and 49.5 g of diisopropanolamine to obtain, as a product, Example 2 which was characterised as follows:
AV=10.1 mgKOH/g, molecular weight Mn=5500

### Example 3

An analogous procedure to that described in Example 2 was followed using the following amounts of starting materials: 131.7 g of hexahydrophthalic anhydride, 488.3 g of polyethyleneglycol monomethyl ether with average molecular weight of 2000, 31.2 g of piperidine and 48.8 g of diisopropanolamine to obtain, as a product, Example 3 which was characterised as follows: AV=10.0 mgKOH/g, molecular weight Mn=5500

### Example 4

An analogous procedure to that described in Example 2 was followed using the following amounts of starting materials: 132.7 g of hexahydrophthalic anhydride, 491.9 g of polyethyleneglycol monomethyl ether with average molecular weight of 2000, 26.2 g of pyrrolidine and 49.1 g of diisopropanolamine to obtain, as a product, Example 4 which was characterised as follows:
AV=8.6 mgKOH/g, Theoretical molecular weight Mn=5500

### Example 5

A double walled glass reactor, which can be heated by means of thermal oil, fitted with a mechanical stirrer, a distillation head, a vacuum and nitrogen connection was heated to 85° C. The reactor is charged with 147.6 of hexahydrophthalic anhydride and 463.0 g of polyethyleneglycol monomethyl ether with average molecular weight of 2000 was added. The reaction mixture was stirred for 1 hour and 10.3 g of piperazine and 31.3 g of morpholine were added. Then the temperature was raised to 120° C. and after stirring for 1 hour 47.8 g of diisopropanolamine was added. The temperature was increased to 160° C. and after 30 minutes the pressure was gradually reduced to a final pressure of <10 mbar to distil off reaction water. Heating and vacuum were maintained until the residual carboxylic acid content was <0.3 meq/g (tritrimetrical analysis) to obtain, as a product, Example 5 which was characterised as follows:
AV=8.6 mgKOH/g. molecular weight Mn=5700

### COMPARATIVE EXAMPLES

### Preparation of Highly Branched Polyester Amides Containing no Polyethylene Glycol (Hydroxyl) End Groups.

### Comp 1

A double walled glass reactor, which can be heated by means of thermal oil, fitted with a mechanical stirrer, a distillation head, a vacuum and nitrogen connection, is charged with 192.5 g of succinic anhydride. The reactor was heated to 125° C. When the succinic anhydride has melted 307.5 g of diisopropanolamine was added. The reaction mixture was stirred for 1 hour and then the temperature was raised to 160° C. Over a period of 4 hours the pressure was gradually reduce to a final pressure of <10 mbar to distil off reaction water. Heating and vacuum were maintained until the residual carboxylic acid content was <0.2 meq/g (tritrimetrical analysis). molecular weight Mn=1200. AV=5.2 mgKOH/g

### Comp 2

A double walled glass reactor, which can be heated by means of thermal oil, fitted with a mechanical stirrer, a distillation head, a vacuum and nitrogen connection, is charged with 245.5 g of hexahydrophthalic anhydride. The reactor was heated to 80° C. When the anhydride has melted 254.5 g of diisopropanolamine was added. The reaction mixture was stirred for 1 hour and then the temperature was raised to 160° C. Over a period of 4 hours the pressure was gradually reduce to a final pressure of <10 mbar to distil off reaction water. Heating and vacuum were maintained until the residual carboxylic acid content was <0.2 meq/g (tritrimetrical analysis), molecular weight Mn=1500. AV=6.4 mgKOH/g.

TABLE 1
Cloud points

| | Mn polyethylene | Cloud point (° C.) | | | |
|---|---|---|---|---|---|
| | glycol chain/ | DMW | | BRINE | |
| Example | Daltons | pH = 4 | pH = 9 | pH = 4 | pH = 9 |
| Ex 1 | 5000 | >100 | >100 | 63 | 63 |
| Ex 2 | 2000 | 100 | | 58 | |
| Ex 3 | 2000 | 99 | | 54 | |
| Ex 4 | 2000 | 89 | | 51 | |
| Ex 5 | 2000 | 84 | | 51 | |
| Comp 1 | — | 84 | | 14 | |
| Comp 2 | — | insoluble | | insoluble | |

### Kinetic Hydrate Inhibition Effect

The ability of different polyester amide compounds comprising at least one ammonium functional end group to prevent hydrate formation was tested by using a “rolling ball apparatus”. The rolling ball apparatus basically comprises a cylindrical cell that contains a stainless steel ball, which can freely roll back and forth over the entire (axial) length of the cell when the cell is tilted. The cell is equipped with a pressure transducer to allow a reading of the gas pressure in the cell and some auxiliary tubing to facilitate cleaning and filling of the cell. The total volume of the cell (including auxiliary tubing) is 46.4 ml. After being filled (a at a pre-defined temperature that is higher than the hydrate dissociation temperature) with water and/or a polyester amide compound and/or condensate or oil, the cell is pressurized to a pre-defined pressure with a synthetic natural gas with a known composition. A set of 24 separate cells, each containing the same or different contents can be mounted horizontally in a rack that is placed in a thermally insulated container through which a water/glycol mixture is circulated. The temperature of the water/glycol mixture can be carefully controlled with an accuracy better than one tenth of a degree Celsius. During the entire experiment, the main body of each cell (i.e., the cylinder) remains submersed in the water/glycol mixture. The entire assembly (cells plus rack plus insulated container) is mounted on an electrically powered seesaw, which, when activated, causes the stainless steel balls to roll back and forth over the entire length of the cells once every eight seconds.

Stagnant pipeline shut-in conditions are simulated by leaving the cells stationary (in horizontal position) during a pre-determined period. Flowing pipeline conditions are simulated by switching on the seesaw such that the balls continuously agitate the liquid contents of the cells.

The ability of some polyester amide compounds to prevent hydrate formation (kinetic inhibition effect) under flowing conditions was tested during the following rolling ball experiments.

### Comparative Example 3

### Blank Experiment

At 24° C., 12 g of demineralized water at a pH of 4 was added to the testing cell in the rolling ball apparatus. Then the cell was pressurized with Gas 1 and the mixture was equilibrated such that at 24° C., the pressure in the cells was 79.1 barg. The cell was mounted on the rack and subsequently immersed in the water/glycol mixture and brought to a temperature of 9.4° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 17.8° C., so this experiment was carried out at a subcooling of 8.4° C. In this experiment hydrates were formed after 1 hour.

### Comparative Example 4

### Citric Acid

At 24° C., 12 g of demineralized water, with 1.5 wt % of citric acid, at a pH of 4 was added to the testing cell in the rolling ball apparatus. Then the cell was pressurized with Gas 1 and the mixture was equilibrated such that at 24° C., the pressure in the cells was 79.1 barg. The cell was mounted on the rack and subsequently immersed in the water/glycol mixture and brought to a temperature of 9.6° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 17.8° C., so this experiment was carried out at a subcooling of 8.2° C. This experiment was carried out in duplicate and in both tests, hydrates were formed in less than 1 hour.

### Comparative Example 5

### Highly Branched Polyester Amide

At 24° C., 12 g of demineralized water, with 0.9 wt % of a highly branched polyester amide not containing ammonium end groups, at a pH of 4 was added to the testing cell in the rolling ball apparatus. Then the cell was pressurized with Gas 1 and the mixture was equilibrated such that at 24° C., the pressure in the cells was 79.1 barg. The cell was mounted on the rack and subsequently immersed in the water/glycol mixture and brought to a temperature of 9.4° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 17.8° C., so this experiment was carried out at a subcooling of 8.4° C. In this experiment hydrates were formed after 1.1 hours.

### Comparative Example 6

### Highly Branched Polyester Amide

At 24° C., 12 g of demineralized water, with 0.9 wt % of a different highly branched polyester amide not containing ammonium end groups, at a pH of 4 was added to the testing cell in the rolling ball apparatus. Then the cell was pressurized with Gas 1 and the mixture was equilibrated such that at 24° C., the pressure in the cells was 79.1 barg. The cell was mounted on the rack and subsequently immersed in the water/glycol mixture and brought to a temperature of 9.4° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 17.8° C., so this experiment was carried out at a subcooling of 8.4° C. In this experiment hydrates were formed after 1.2 hours.

### Example 6

### Polyester Amide Compound with Polyalkylene Glycol End Groups

At 24° C., 12 g of demineralized water, with 0.9 wt % of a highly branched polyester amide containing polyalkylene glycol end groups, at a pH of 4 was added to the testing cell in the rolling ball apparatus. Then the cell was pressurized with Gas 1 and the mixture was equilibrated such that at 24° C., the pressure in the cells was 79.1 barg. The cell was mounted on the rack and subsequently immersed in the water/glycol mixture and brought to a temperature of 9.6° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 17.8° C., so this experiment was carried out at a subcooling of 8.2° C. This experiment was carried out in duplicate. In both tests, no hydrates were formed during the testing time of 329 hours.

### Example 7

### Polyester Amide Compound with Polyalkylene Glycol End Groups

At 24° C., 12 g of demineralized water, with 0.9 wt % of a highly branched polyester amide containing polyalkylene glycol end groups, at a pH of 4 was added to the testing cell in the rolling ball apparatus. Then the cell was pressurized with Gas 1 and the mixture was equilibrated such that at 24° C., the pressure in the cells was 79.1 barg. The cell was mounted on the rack and subsequently immersed in the water/glycol mixture and brought to a temperature of 9.4° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 17.8° C., so this experiment was carried out at a subcooling of 8.4° C. This experiment was carried out four times. In all the tests, no hydrates were formed during the testing time of 141 hours.

### Example 8

### Polyester Amide Compound with Polyalkylene Glycol End Groups

At 24° C., 12 g of demineralized water, with 0.9 wt % of a highly branched polyester amide containing polyalkylene glycol end groups, at a pH of 4 was added to the testing cell in the rolling ball apparatus. Then the cell was pressurized with Gas 1 and the mixture was equilibrated such that at 24° C., the pressure in the cells was 79.1 barg. The cell was mounted on the rack and subsequently immersed in the water/glycol mixture and brought to a temperature of 9.6° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 17.8° C., so this experiment was carried out at a subcooling of 8.2° C. This experiment was carried out in duplicate. In both tests, no hydrates were formed during the testing time of 329 hours.

### Example 9

### Polyester Amide Compound with Polyalkylene Glycol End Groups

At 24° C., 12 g of demineralized water, with 0.9 wt % of a highly branched polyester amide containing polyalkylene glycol end groups, at a pH of 4 was added to the testing cell in the rolling ball apparatus. Then the cell was pressurized with Gas 1 and the mixture was equilibrated such that at 24° C., the pressure in the cells was 79.1 barg. The cell was mounted on the rack and subsequently immersed in the water/glycol mixture and brought to a temperature of 9.5° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 17.7° C., so this experiment was carried out at a subcooling of 8.2° C. This experiment was carried out in triplicate. In all the tests, no hydrates were formed during the testing time of 168 hours.

At 20° C., 3.6 g of demineralized water, at a pH of 4 was added to the testing cell in the rolling ball apparatus. 8.4 ml (6.38 g) of condensate were added to the cell. In addition, 0.9 wt % of a highly branched polyester amide containing polyalkylene glycol end groups was added. Then the cell was pressurized with Gas 2 and the mixture was equilibrated such that at 20° C., the pressure in the cells was 36 barg. The cell was mounted on the rack and subsequently immersed in the water/glycol mixture and brought to a temperature of 3.0° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 11.0° C., so this experiment was carried out at a subcooling of 8.0° C. This experiment was carried out in triplicate. In all three tests, no hydrates were formed during the testing time of 249 hours.

### Example 10

### Polyester Amide Compound with Polyalkylene Glycol End Groups

At 24° C., 12 g of demineralized water, with 0.9 wt % of a highly branched polyester amide containing polyalkylene glycol end groups, at a pH of 4 was added to the testing cell in the rolling ball apparatus. Then the cell was pressurized with Gas 1 and the mixture was equilibrated such that at 24° C., the pressure in the cells was 79.1 barg. The cell was mounted on the rack and subsequently immersed in the water/glycol mixture and brought to a temperature of 9.5° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 17.7° C., so this experiment was carried out at a subcooling of 8.2° C. This experiment was carried out in triplicate. In all the tests, no hydrates were formed during the testing time of 168 hours.

At 20° C., 3.6 g of demineralized water, at a pH of 4 was added to the testing cell in the rolling ball apparatus. 8.4 ml (6.38 g) of condensate were added to the cell. In addition, 0.9 wt % of a highly branched polyester amide containing polyalkylene glycol end groups was added. Then the cell was pressurized with Gas 2 and the mixture was equilibrated such that at 20° C., the pressure in the cells was 36 barg. The cell was mounted on the rack and subsequently immersed in the water/glycol mixture and brought to a temperature of 3.0° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 11.0° C., so this experiment was carried out at a subcooling of 8.0° C. This experiment was carried out in triplicate. In all three tests, no hydrates were formed during the testing time of 249 hours.

### Example 11

### Polyester Amide Compound with Polyalkylene Glycol End Groups

At 24° C., 12 g of demineralized water, with 0.9 wt % of a highly branched polyester amide containing polyalkylene glycol end groups, at a pH of 4 was added to the testing cell in the rolling ball apparatus. Then the cell was pressurized with Gas 1 and the mixture was equilibrated such that at 24° C., the pressure in the cells was 79.1 barg. The cell was mounted on the rack and subsequently immersed in the water/glycol mixture and brought to a temperature of 9.5° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 17.7° C., so this experiment was carried out at a subcooling of 8.2° C. This experiment was carried out in triplicate. In all the tests, no hydrates were formed during the testing time of 168 hours.

At 20° C., 3.6 g of demineralized water, at a pH of 4 was added to the testing cell in the rolling ball apparatus. 8.4 ml (6.38 g) of condensate were added to the cell. In addition, 0.9 wt % of a highly branched polyester amide containing polyalkylene glycol end groups was added. Then the cell was pressurized with Gas 2 and the mixture was equilibrated such that at 20° C., the pressure in the cells was 36 barg. The cell was mounted on the rack and subsequently immersed in the water/glycol mixture and brought to a temperature of 3.0° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 11.0° C., so this experiment was carried out at a subcooling of 8.0° C. This experiment was carried out in triplicate. In all three tests, no hydrates were formed during the testing time of 249 hours.

### Example 12

### Polyester Amide Compound with Polyalkylene Glycol End Groups

At 24° C., 12 g of demineralized water, with 0.9 wt % of a highly branched polyester amide containing polyalkylene glycol end groups, at a pH of 4 was added to the testing cell in the rolling ball apparatus. Then the cell was pressurized with Gas 1 and the mixture was equilibrated such that at 24° C., the pressure in the cells was 79.1 barg. The cell was mounted on the rack and subsequently immersed in the water/glycol mixture and brought to a temperature of 9.5° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 17.7° C., so this experiment was carried out at a subcooling of 8.2° C. This experiment was carried out in triplicate. In all the tests, no hydrates were formed during the testing time of 168 hours.

At 20° C., 3.6 g of demineralized water, at a pH of 4 was added to the testing cell in the rolling ball apparatus. 8.4 ml (6.38 g) of condensate were added to the cell. In addition, 0.9 wt % of a highly branched polyester amide containing polyalkylene glycol end groups was added. Then the cell was pressurized with Gas 2 and the mixture was equilibrated such that at 20° C., the pressure in the cells was 36 barg. The cell was mounted on the rack and subsequently immersed in the water/glycol mixture and brought to a temperature of 3.0° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 11.0° C., so this experiment was carried out at a subcooling of 8.0° C. This experiment was carried out in triplicate. In all three tests, no hydrates were formed during the testing time of 249 hours.

### Example 13

### Polyester Amide Compound with Polyalkylene Glycol End Groups

At 24° C., 12 g of demineralized water, with 0.9 wt % of a highly branched polyester amide containing polyalkylene glycol end groups, at a pH of 4 was added to the testing cell in the rolling ball apparatus. Then the cell was pressurized with Gas 1 and the mixture was equilibrated such that at 24° C., the pressure in the cells was 79.1 barg. The cell was mounted on the rack and subsequently immersed in the water/glycol mixture and brought to a temperature of 9.4° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 17.8° C., so this experiment was carried out at a subcooling of 8.4° C. This experiment was carried out in duplicate. In both tests, no hydrates were formed during the testing time of 208 hours.

At 20° C., 3.6 g of demineralized water, at a pH of 4 was added to the testing cell in the rolling ball apparatus. 8.4 ml (6.38 g) of condensate were added to the cell. In addition, 0.9 wt % of a highly branched polyester amide containing polyalkylene glycol end groups was added. Then the cell was pressurized with Gas 2 and the mixture was equilibrated such that at 20° C., the pressure in the cells was 36 barg. The cell was mounted on the rack and subsequently immersed in the water/glycol mixture and brought to a temperature of 2.0° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 11.0° C., so this experiment was carried out at a subcooling of 9.0° C. This experiment was carried out in duplicate. In the first test, hydrates were formed at 177 hours and in the second test, no hydrates were formed during the testing time of 338 hours.

### Example 14

### Polyester Amide Compound with Polyalkylene Glycol End Groups

At 24° C., 12 g of demineralized water, with 0.9 wt % of a highly branched polyester amide containing polyalkylene glycol end groups, at a pH of 4 was added to the testing cell in the rolling ball apparatus. Then the cell was pressurized with Gas 1 and the mixture was equilibrated such that at 24° C., the pressure in the cells was 79.1 barg. The cell was mounted on the rack and subsequently immersed in the water/glycol mixture and brought to a temperature of 9.4° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 17.8° C., so this experiment was carried out at a subcooling of 8.4° C. This experiment was carried out in triplicate. In the first test, hydrates formed at 110 hours. In the second and third tests, no hydrates were formed during the testing time of 141 hours.

### Example 15

### Polyester Amide Compound with Polyalkylene Glycol End Groups

At 24° C., 12 g of demineralized water, with 0.9 wt % of a highly branched polyester amide containing polyalkylene glycol end groups, at a pH of 4 was added to the testing cell in the rolling ball apparatus. Then the cell was pressurized with Gas 1 and the mixture was equilibrated such that at 24° C., the pressure in the cells was 79.1 barg. The cell was mounted on the rack and subsequently immersed in the water/glycol mixture and brought to a temperature of 9.4° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 17.8° C., so this experiment was carried out at a subcooling of 8.4° C. This experiment was carried out in duplicate. In both tests, no hydrates were formed during the testing time of 208 hours.

At 20° C., 3.6 g of demineralized water, at a pH of 4 was added to the testing cell in the rolling ball apparatus. 8.4 ml (6.38 g) of condensate were added to the cell. In addition, 0.9 wt % of a highly branched polyester amide containing polyalkylene glycol end groups was added. Then the cell was pressurized with Gas 2 and the mixture was equilibrated such that at 20° C., the pressure in the cells was 36 barg. The cell was mounted on the rack and subsequently immersed in the water/glycol mixture and brought to a temperature of 2.0° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 11.0° C., so this experiment was carried out at a subcooling of 9.0° C. This experiment was carried out in duplicate. In both tests, no hydrates were formed during the testing time of 338 hours.

### Example 16

### Polyester Amide Compound with Polyalkylene Glycol End Groups

At 24° C., 12 g of demineralized water, with 0.9 wt % of a highly branched polyester amide containing polyalkylene glycol end groups, at a pH of 4 was added to the testing cell in the rolling ball apparatus. Then the cell was pressurized with Gas 1 and the mixture was equilibrated such that at 24° C., the pressure in the cells was 79.1 barg. The cell was mounted on the rack and subsequently immersed in the water/glycol mixture and brought to a temperature of 9.4° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 17.8° C., so this experiment was carried out at a subcooling of 8.4° C. This experiment was carried out in duplicate. In both tests, no hydrates were formed during the testing time of 208 hours.

At 20° C., 3.6 g of demineralized water, at a pH of 4 was added to the testing cell in the rolling ball apparatus. 8.4 ml (6.38 g) of condensate were added to the cell. In addition, 0.9 wt % of a highly branched polyester amide containing polyalkylene glycol end groups was added. Then the cell was pressurized with Gas 2 and the mixture was equilibrated such that at 20° C., the pressure in the cells was 36 barg. The cell was mounted on the rack and subsequently immersed in the water/glycol mixture and brought to a temperature of 2.0° C. The seesaw was activated such that the stainless steel balls rolled back and forth over the entire (axial) length of the cells once every eight seconds. The pressure in the cells was monitored to determine when hydrates were formed. Hydrate formation is characterized by a sharp decline in pressure. It is calculated that hydrates can form under these conditions at a temperature of 11.0° C., so this experiment was carried out at a subcooling of 9.0° C. This experiment was carried out in duplicate. In the first test, hydrates were formed in 142 hours, and in the second test hydrates were formed in 140 hours.

1. A method for inhibiting the plugging of a conduit containing a flowable mixture comprising at least an amount of hydrocarbons capable of forming hydrates in the presence of water and an amount of water, which method comprises adding to the mixture an amount of a hyper-branched polyester amide compound effective to inhibit formation and/or accumulation of hydrates in the mixture at conduit temperatures and pressures; and flowing the mixture containing the polyester amide compound and any hydrates through the conduit wherein the polyester amide compound comprises at least one polyalkylene glycol functional end group.

2. The method of claim 1 wherein the functionalized dendrimer is a hyper-branched polyester amide.

3. The method of claim 1 in which between about 0.05 to about 10 wt % of the functionalized dendrimer, based on the amount of water in the hydrocarbon-containing mixture is added to the mixture.

4. The method of claim 1 wherein the functionalized dendrimer has a cloud point of at least 50° C. in brine.

5. The method of claim 1 wherein the functionalized dendrimer has a cloud point of at least 80° C. in brine.
